(19) United States
(12) Patent Application Publication
(10) Pub. No.: US 2007/0104465 A1
(43) Pub. Date: May 10, 2007

(54) Device and method for recording information

(75) Inventor: Paulus Thomas Arnoldus Thijssen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/557,692

(22) PCT Filed: May 18, 2004
(86) PCT No.: PCT/IB04/50726

§ 371 Date: Nov. 22, 2005

(30) Foreign Application Priority Data
May 28, 2003 (EP) 03101564.7

(51) Int. Cl. H04N 7/26

(52) U.S. Cl. 386/124

(57) ABSTRACT

A device records a video program on a record carrier according to a predefined recording format, such as DVD. The device has an input unit (27) for receiving the video. The program includes menus for display on a screen for providing user control for accessing the program. The device has a menu unit (33) for generating menus according to a layout, and a layout generator (31). The layout includes color parameters for defining the color of items in the menu. Layout data is stored on the record carrier. The device has a layout retrieving unit (32) for retrieving the layout data from the record carrier for generating menus when recordings are made on the record carrier.

The invention relates to a device for recording information

The invention further relates to a method of recording information.

The invention further relates to a computer program product for recording information.

The invention further relates to a record carrier.

A device and method for recording information on a record carrier are known from U.S. Pat. No. 5,963,704, in which digitally compressed video data is recorded on a record carrier according to a video encoding standard, for example the MPEG2 format. A data stream includes video and navigation information such as menus for accessing the video content. A method to form a menu is described, in which a background image and sub-picture data are combined with active elements like buttons for providing user control for selecting specific parts of the video to be reproduced or changing settings for the reproduction. The layout of the menu, such as colors of the menu items, background and highlight information are defined according to a predefined recording format, which substantially corresponds to the recording format called Digital Versatile Disc (DVD). The menus are conceived by the producer of the record carrier, in particular the editor of the prerecorded disc. However, nowadays video recording systems are available to the consumer for recording real-time information on a record carrier according to predefined recording formats like DVD. Menus for accessing the recorded video programs are generated by the recording device of the consumer. However, the capabilities of generating the menus by a consumer device are limited, and may vary for different device types. Control over the layout of the menus is rigid and resides with the different device types

It is an object of the invention to provide a system for recording and reproducing programs of real-time information including menus, wherein the layout of the menus is more flexible and versatile.

According to a first aspect of the invention a device for recording information on a record carrier comprises an input unit for receiving real-time information, in particular video, recording means for recording marks representing a program according to a predefined recording format, the program including the real-time information and at least one menu for display on a screen for providing user control for accessing the program, menu means for generating the menu according to a layout, layout means for generating the layout, the layout including color parameters for defining the color of items in the menu, and for storing the layout on the record carrier and retrieving the layout from the record carrier.

According to a second aspect of the invention a method of recording information on a record carrier comprises receiving real-time information, in particular video, recording marks representing a program according to a predefined recording format, the program including the real-time information and at least one menu for display on a screen for providing user control for accessing the program, generating the menu according to a layout, generating the layout, the layout including color parameters for defining the color of items in the menu, and storing the layout on the record carrier and retrieving the layout from the record carrier.

According to a third aspect of the invention a record carrier for carrying information representing a program according to a predefined recording format, the program including real-time information, in particular video, and at least one menu for display on a screen for providing user control for accessing the program, comprises a track containing prerecorded information representing a layout to be used for generating the menu, the layout including color parameters for defining the color of items in the menu

The measures have the effects that the menus for programs recorded on a single record carrier are created using a single layout. This has the advantage that the user will see and recognize a same menu, even if the programs are recorded by different recording devices. Further the layout defined in a specific way for a specific record carrier will be applied for all the menus on that record carrier (unless selected otherwise). Having a prerecord menu layout on a record carrier provides a way of manufacturing record carriers which have added value for a user, for example by providing discs with dedicated menus for certain program types (e.g. sports, soaps or special events).

The invention is also based on the following recognition. The inventors have seen that menus generated in existing consumer recording devices are determined by “factory build in” menu layouts. According to the invention at least some layout parameters are recorded on and retrieved from the record carrier, which provides the option to create menus consistently for that record carrier. It is to be noted that the layout of the menus usually will partly be based on predefined layout settings build in the device, and partly on variable data stored and retrieved on the record carrier according to the invention. The predefined layout settings may be standardized and devices may even have several sets of layout settings. The standardized recording format may indicate a specific set of predefined layout settings used on the record carrier. This for example allows recording devices of a specific manufacturer to use a basic predefined menu layout defined for that manufacturer, whereas the layout parameters retrieved from the record carrier allow different variations of the basic layout, e.g. different color schemes for different generations of devices of that manufacturer.

In an embodiment of the device the layout means are arranged for defining the color by specifying a number of entries to be used from a color table, in particular the table being a subpicture color palette stored according to the predefined recording format. In a further embodiment the predefined recording format is a DVD format and wherein the layout means are arranged for defining the color by specifying 4 entries out of 16 colors defined for the subpicture in a program chain general information (PGC-GI). This has the advantage that colors defined in a color table are used for the recorded menus, and are also used for other purposes. Hence a consistent use of colors is achieved.

In an embodiment of the device the menu means are arranged for providing at least one device menu for display on a screen for providing user control of functions of the device, the device menu being generated according to a layout retrieved from the record carrier. This has the advantage that device menus made available to the user for manipulating the contents of the record carrier will have the same layout as the menus recorded on that record carrier. The user will experience an increased control over the record carrier, because the same menu layout is used.

Further preferred embodiments of the recording or reading device, the record carrier, and method according to the invention are given in the claims.

These and other aspects of the invention will be apparent from and elucidated further with reference to the embodiments described by way of example in the following description and with reference to the accompanying drawings, in which

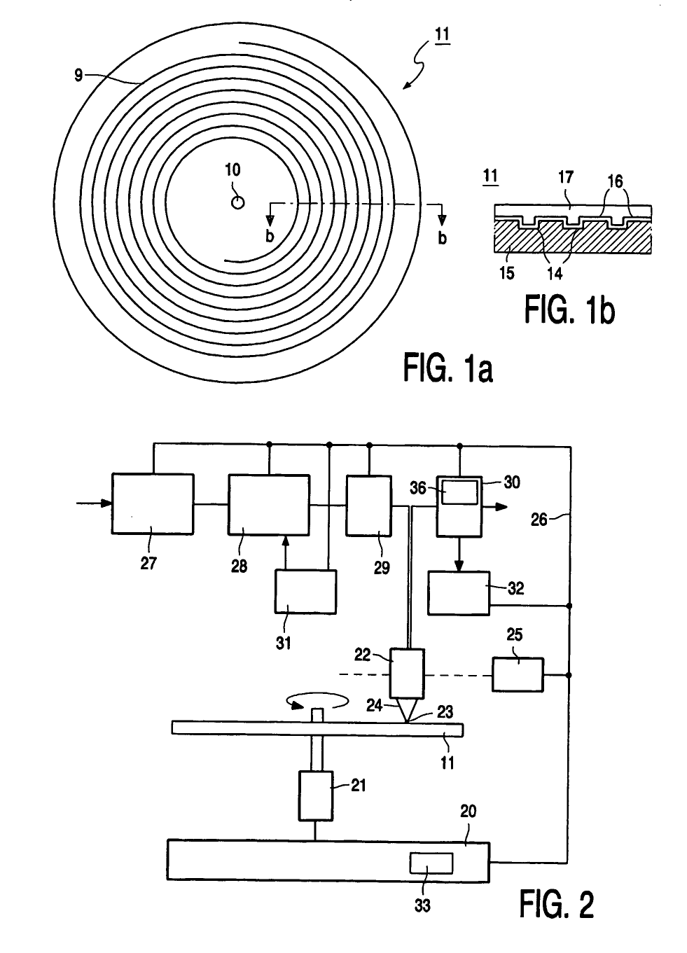

FIG. 1a shows a record carrier (top view),

FIG. 1b shows a record carrier (cross section),

FIG. 2 shows a recording device,

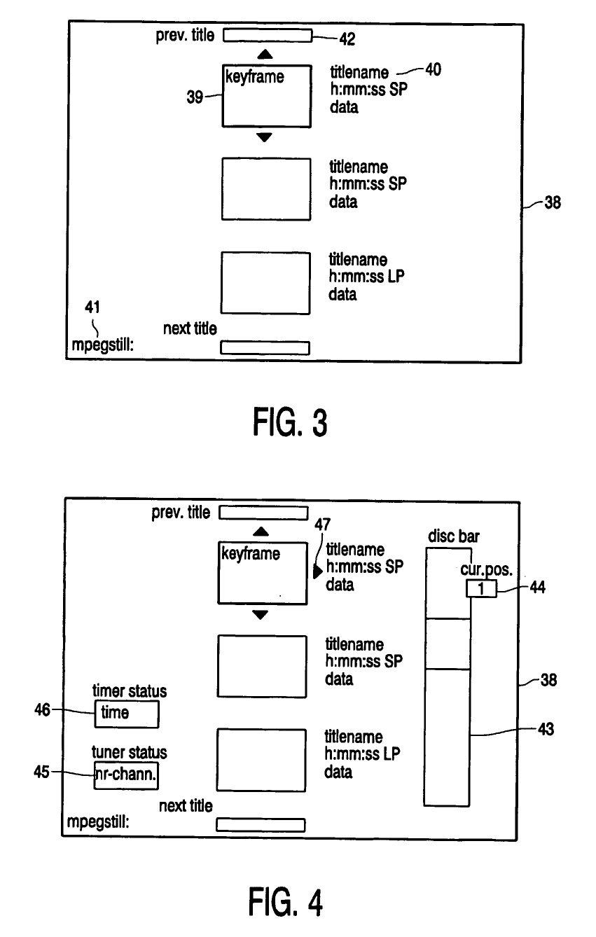

FIG. 3 shows a menu for a table of contents for playback,

FIG. 4 shows a menu for a table of contents for recording,

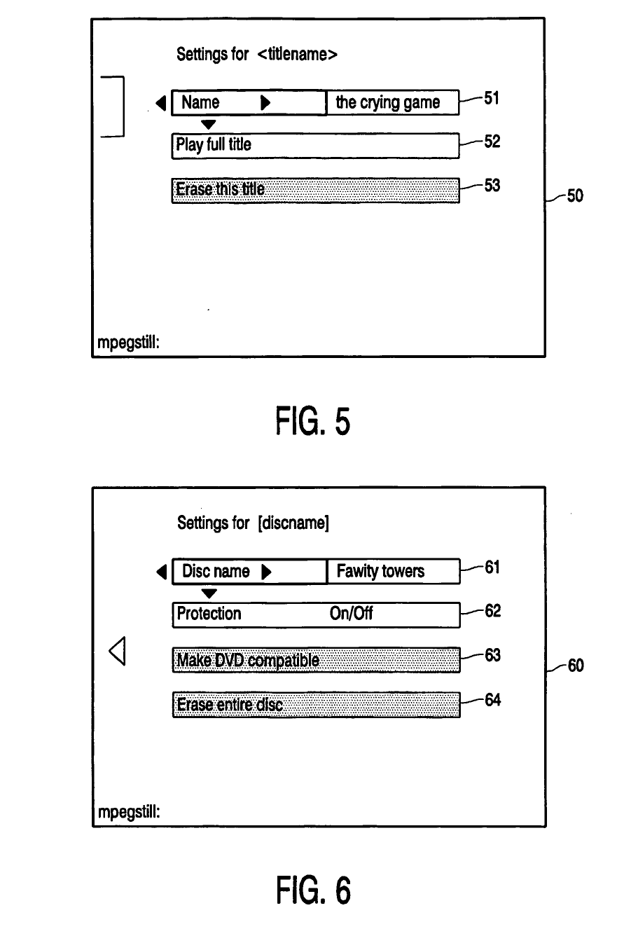

FIG. 5 shows a menu for entering program properties,

FIG. 6 shows a menu for manipulating the disc, and

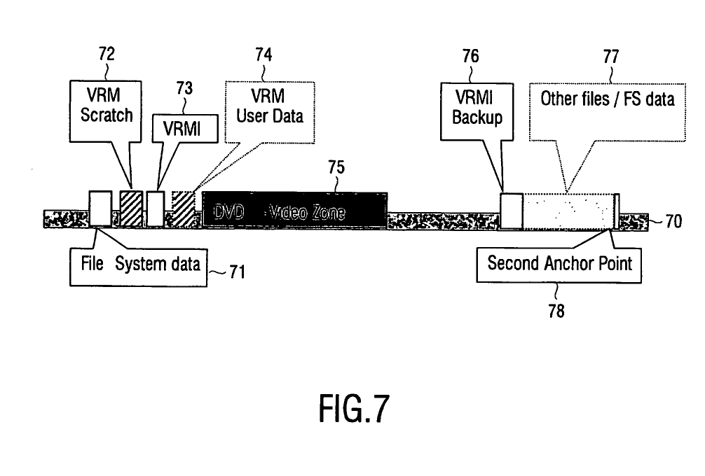

FIG. 7 shows an overview of a recording area on a recordable DVD.

Corresponding elements in different Figures have identical reference numerals.

FIG. 1a shows a disc-shaped record carrier 11 having a track 9 and a central hole 10. The track 9, being the position of the series of (to be) recorded marks representing information, is arranged in accordance with a spiral pattern of turns constituting substantially parallel tracks on an information layer. The record carrier may be optically readable, called an optical disc, and has an information layer of a recordable type. Examples of a recordable disc are the CD-R and CD-RW, and writable versions of DVD, such as DVD+RW, and the high density writable optical disc using blue lasers, called Blue-ray Disc (BD). The information is represented on the information layer by recording optically detectable marks along the track, e.g. crystalline or amorphous marks in phase change material. The track 9 on the recordable type of record carrier is indicated by a pre-embossed track structure provided during manufacture of the blank record carrier. The track structure is constituted, for example, by a pregroove 14, which enables a read/write head to follow the track during scanning. The track structure comprises position information, e.g. addresses, for indication the location of units of information, usually called information blocks.

FIG. 1b is a cross-section taken along the line b-b of the record carrier 11 of the recordable type, in which a transparent substrate 15 is provided with a recording layer 16 and a protective layer 17. The protective layer 17 may comprise a further substrate layer, for example as in DVD where the recording layer is at a 0.6 mm substrate and a further substrate of 0.6 mm is bonded to the back side thereof. The pregroove 14 may be implemented as an indentation or an elevation of the substrate 15 material, or as a material property deviating from its surroundings.

The record carrier 11 is intended for carrying information representing digitally encoded video like MPEG2 encoded video information recorded according to a predefined recording format like the DVD format. Further details about the DVD disc can be found in reference: ECMA-267: 120 mm DVD—Read-Only Disc—(1997), and corresponding DVD video recording specifications. The BD recording format is described in the System Description Blue-Ray Disc Rewritable Format, in particular Part 3: Audio Visual Specifications, version 1.0, June 2002.

FIG. 2 shows a recording device for writing information on a record carrier 11 of a type, which is writable or re-writable, for example CD-R or CD-RW, or DVD+RW or BD. The device is provided with recording means for scanning the track on the record carrier, which means include a drive unit 21 for rotating the record carrier 11, a head 22, a positioning unit 25 for coarsely positioning the head 22 in the radial direction on the track, and a control unit 20. The head 22 comprises an optical system of a known type for generating a radiation beam 24 guided through optical elements focused to a radiation spot 23 on a track of the information layer of the record carrier. The radiation beam 24 is generated by a radiation source, e.g. a laser diode. The head further comprises (not shown) a focusing actuator for moving the focus of the radiation beam 24 along the optical axis of said beam and a tracking actuator for fine positioning of the spot 23 in a radial direction on the center of the track. The tracking actuator may comprise coils for radially moving an optical element or may alternatively be arranged for changing the angle of a reflecting element. For writing information the radiation is controlled to create optically detectable marks in the recording layer. The marks may be in any optically readable form, e.g. in the form of areas with a reflection coefficient different from their surroundings, obtained when recording in materials such as dye, alloy or phase change material, or in the form of areas with a direction of magnetization different from their surroundings, obtained when recording in magneto-optical material. For reading the radiation reflected by the information layer is detected by a detector of a usual type, e.g. a four-quadrant diode, in the head 22 for generating a read signal and further detector signals including a tracking error and a focusing error signal for controlling said tracking and focusing actuators. The read signal is processed by read processing unit 30 of a usual type including a demodulator, deformatter and output unit to retrieve the information. Hence retrieving means for reading information include the drive unit 21, the head 22, the positioning unit 25 and the read processing unit 30. The device may include a rendering unit 36 coupled to the read processing unit 30 for rendering real-time information, for example a display screen for rendering video information.

The device comprises write processing means for processing the input information to generate a write signal to drive the head 22, which means comprise an input unit 27, and a formatter 28 and a modulator 29. The control unit 20 controls the recording and retrieving of information and may be arranged for receiving commands from a user or from a host computer. The control unit 20 is connected via control lines 26, e.g. a system bus, to said input unit 27, formatter 28 and modulator 29, to the read processing unit 30, and to the drive unit 21, and the positioning unit 25. The control unit 20 comprises control circuitry, for example a microprocessor, a program memory and control gates, for performing the procedures and functions according to the invention as described below. The control unit 20 may also be implemented as a state machine in logic circuits.

In operation the device will record real-time data received via the input unit 27 and processed in the formatter 28 as a program according to a predefined recording format, for example a video program recorded according to the DVD recording format. The received real-time data of a selected program is passed to the formatter 28 for generating control data and formatting the data as prescribed by the predefined recording format. The formatted data from the output of the formatter 28 is passed to the modulation unit 29, which comprises for example a channel coder, for generating a modulated signal, which drives the head 22. Further the modulation unit 29 comprises synchronizing means for including synchronizing patterns in the modulated signal. The formatted information presented to the input of the modulation unit 29 comprise address information and is written to corresponding addressable locations on the record carrier under the control of control unit 20 according to the predefined recording format. It is to be noted that further in the text reference is made to the predefined recording format of the DVD+RW as an example of such a format. However other predefined recording formats such as BD may be used also.

Using a predefined recording format allows existing read devices to play back the recorded program. The device has a menu unit 33 for generating menus to be included in the recorded program, which menus are compliant to the predefined recording format. Examples and details of the menus generated are described below with reference to FIGS. 3 to 6. The menu unit may be implemented as a function of the control unit 20, e.g. performed by built-in software. The data structure of the menus is known from the recording format, for example the DVD video standard.

The device is provided with a layout generator 31, which provides layout data to the control unit 20 for use in the menu unit 33. Further the device has a layout retrieving unit 32 for retrieving layout data from the record carrier via the read processing unit 30. The layout data is stored in files, and is retrieved using file system data. Alternatively the layout data is stored in a specific predefined location on the record carrier. The control unit will first detect if layout data is available from the record carrier via the layout retrieving unit 32. If no layout data is available, or in addition to layout data retrieved from the record carrier the control unit may receive layout data from the layout generator 31. In an embodiment the layout of the generated menus is based on a basic layout specification as prescribed by a standard in combination with the retrieved or generated layout data.

In an embodiment the record carrier contains layout data as prerecorded information, for example recorded in a predefined area of the track or encoded in a wobble of the pregroove 14. The layout retrieving unit 32 is provided with a track decoding unit for retrieving information encoded in the track, for example via other readout signals such as servo signals.

An embodiment of the recording device is called DVD Video Recorder and is arranged for recording video data according to the DVD format. For accessing recorded information a recording model follows the so called ‘tape model’ known from VCR. This means that recordings are put linearly on a disc. Also, recordings can be (partially) overwritten similarly to recordings on a tape. One of the key features of the recording device for accessing the recorded programs is a Table Of Contents (TOC). The TOC provides an overview of all recordings on the disc. A menu is defined to specify how the TOC is presented to the user.

FIG. 3 shows a menu for a table of contents for playback. On a menu screen 38 the user can navigate to all recordings and start playback. The items in the menu may have the function of a button, i.e. they may be selected by the user via a remote control unit and activated for controlling a function of the device. For each recorded program a keyframe 39 is displayed constituting a series of menu items with a corresponding subpicture (SP) 40, for example a title, a recording time in hours minutes and seconds (h:mm:ss) and a recording date. If more programs are recorded the menu may contain a previous title item 42 and/or a next title item, which may be activated for accessing further recordings. The background of the menu is constituted by an image 41 (mpegstill), for example a still picture encoded via the MPEG standard.

The layout items are formed according to a graphics color scheme in the menu layout definition. DVD specifies that the subpicture color palette is defined in the PGC General Information (see section 4.3.2 of the DVD Video Specification, DVD Specifications for Read-Only Disc art 3, Video Specifications; Version 1.0, August 1996). This palette is static and consists of 16 entries. The subpicture is represented by a bitmap having 2 bit per pixel. In the subpicture stream there is a dynamic indication which of the 16 entries are applicable.

The menu layout defines which entries of the subpicture palette apply for the menu, and must be used when generating the menus. Hence the layout parameters to be recorded on the record carrier and retrieved from the record carrier include the color parameters to be used. In an embodiment the background image to be used for the menus is included in the layout parameters.

In an embodiment the layout generator is provided with a user interface for setting the colors and/or selecting the background. This feature enables the customer to select a picture to be used as menu background for a certain disc, and setting colors that are suitable for a selected background (either from a fixed set of color schemes, or via an extended color setting where any colour scheme can be selected).

In an embodiment the function of recording, layout generation and menu authoring is implemented in a computer program for a PC having a recording unit, e.g. a DVD+RW drive. PC editing applications may author nice menu's that still use the menu layout recorded on the record carrier; or a user defined layout may be recorded on the record carrier using the resources of the PC.

FIG. 4 shows a menu for a table of contents for recording. The menu is available only as a user interface on the recording device itself, and is not included in the recorded program. On the DVD Video Recorder, the TOC menu provides more information (compared to FIG. 3). The additional items include a disc bar 43 with a disc pointer 44. Further a button may be provided to active a different menu for entering text data such as a title, or a button for entering a disc manipulation menu (see FIGS. 5 and 6). Furthermore a tuner status item 45 for displaying a selected channel number and a timer status item 46 may be included.

It is to be noted that the menu as shown in FIG. 3 is visible on a DVD player, and is authored to be recorded on the disc as a DVD menu. Note that in the DVD recording format there is hardly any difference between a menu and a normal movie: both consist of an audio/video/graphics stream. The DVD Video Recorder authors TOC screens as follows: the background and the key frames together are encoded as an MPEG still; the text is encoded as DVD subpictures. The navigation arrows and the selected title indication are encoded as DVD buttons. Subpictures and buttons are graphical items defined in the DVD standard. Buttons can be selected, highlighted and activated by the user for controlling the DVD player.

In an embodiment of the DVD Video Recorder, the additional items shown in FIG. 4 (disc bar 43, timer indication, tuner icon, etc.) are presented as On-Screen Display (OSD), i.e. generated separately and displayed on top of the menu shown in FIG. 3. This requires exact knowledge of how the TOC is authored (number and position of key frames, color/shape/position of graphics, etc.). For example the small right arrow 47 to enter disc or title manipulation menu has to be carefully positioned, because it is generated via OSD whereas the up/down arrows are all encoded as subpictures as part of the menu in FIG. 3.

In a DVD+RW recording standard the TOC menu is specified as optional. The specification prescribes a number of basic layout parameters. For example the specification prescribes the size, position, shape and color of a number of graphical objects of the TOC. Different specifications may prescribe different basic layout parameters. If a recorder writes a TOC menu, it also has to include an indicator which basic menu layout is used. If the recorder recognizes the layout indicator (a so called native disc) it can display the TOC according to the prescribed basic layout parameters. However, if the indicator is unknown to the recorder (a foreign disc), the TOC (if any) must be played like on a DVD playback device, i.e. without the extras. An embodiment of the recorder has a function (for foreign discs) of re-generating the menus according to its own layout. This means that the TOC and other menus are re-authored the TOC according to the known basic layout.

In an embodiment of the DVD Video Recorder the background of the menus is formed as follows. A basic MPEG still picture that is used for the TOC background for new record carriers resides in a Flash memory. After the first recording on an empty disc, the MPEG still from Flash is used to generate the TOC. However, the basic MPEG still is also written in a layout file in a specific area on the record carrier, for example the so-called ‘scratch area’ defined in the DVD+RW standard and that is shown in FIG. 7. Whenever a new recording is made to an existing disc, the MPEG still in the layout file in the scratch area will be used to generate the new TOC pages. If no layout file can be found in the specific area, the MPEG still from the Flash memory will be used. Hence the layout for a specific disc is consistently based on the layout of the first recorder using that disc. As a result, discs can be exchanged easily between different recorders that recognize the layout indicator.

In an embodiment the layout parameters include colors for further menu items. For example the other 12 colors of the DVD subpicture palette can be defined, or assigned to specific menu items, e.g. the timer indication on the disc bar in the menu shown in FIG. 4.

In an embodiment the layout parameters include a bitmap and position information of a graphical item like the ‘arrow right’. This allows a lot more freedom in menu design.

In an embodiment the layout parameters include specific information for an On Screen Display (OSD) object. As the complete information of the OSD object is provided in the layout, no predefined layout for such an object is required and an unlimited extension of the menu layout is provided.

In an embodiment of the recording device the menu background and/or colors and other layout features of device control menus like disc/title manipulation menus are based on the layout file. FIGS. 5 and 6 show examples of device control menus. It is noted that these menus do not reside on the disc, but are generated by the recorder.

FIG. 5 shows a menu for entering program properties. On a menu background 50 an MPEG still is shown. A first field 51 is for entering the title of the program. In a second field 52 further properties or commands may be defined, such as ‘play full title’. A third field 53 is a button for activating the erase function for the program.

FIG. 6 shows a menu for manipulating the disc. On a menu background 60 an MPEG still is shown. A first field 61 is for entering the title of the disc. In a second field 62 further properties or commands may be defined, such as ‘protection’ against erasure. A third field 63 is a button for activating the function for recording control data on the disc to make the disc compatible to the DVD standard for DVD playback devices. A fourth field 64 is a button for activating the erase function for the entire disc.

FIG. 7 shows an overview of a recording area on a recordable DVD. A recordable area 70 is schematically showing the relative location of the various data structures in the volume space of a DVD+RW Video disc. File System data 71 is located before the first DVD+RW Video data and optionally partly after the last DVD+RW Video data in the Other files/FS data area 77. The second Anchor Point 78 contains the backup of the UDF Anchor Volume Descriptor Pointer and is stored in the last sector of the volume space. A Video Recording Manager (VRM) Scratch area 72 is a mandatory area with a fixed size of 1 MB, which may be used by recorders to temporarily store data. VRM Information (VRMI) 73 is mandatory and contains Video Recording Manager Information. It includes information to identify which type of recorder has generated the DVD-Video menus on the disc. VRM User Data 74 are optional data structures stored in one or more files, which may be recorded to add functionality or to improve performance on some recorders. The owner of the VRM User Data is the recorder that has generated the DVD-Video menus. When a disc travels from one recorder to another and the menus are regenerated (e.g. after a new recording was made), the original VRM User Data may be deleted or changed. The DVD-Video Zone 75 contains DVD-Video-like data structures, for example the real-time video data. Finally a VRMI backup 76 contains a bit true copy of VRMI for error recovery purposes.

The layout file containing the layout data is to be stored in a predefined location, for example in the VRM scratch area 72 or in the VRM user data area 74.

Although the invention has been explained mainly by embodiments using the DVD+RW, similar embodiments like BD having a predefined recording format are suitable S for applying the storage of layout-data. Further it is noted that a version of a predefined recording format may standardize a specific format or storage location for the layout file. Also for the record carrier an optical disc has been described, but other media, such as a magneto-optical disc or magnetic tape, can be used. It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ may be represented by the same item of hardware. Further, the scope of the invention is not limited to the embodiments, and the invention lies in each and every novel feature or combination of features described above.

1. Device for recording information on a record carrier, which device comprises
an input unit (27) for receiving real-time information, in particular video,
recording means (22) for recording marks representing a program according to a predefined recording format, the program including the real-time information and at least one menu for display on a screen for providing user control for accessing the program,
menu means (33) for generating the menu according to a layout,
layout means (31,32) for generating the layout, the layout including color parameters for defining the color of items in the menu, and for storing the layout on the record carrier and retrieving the layout from the record carrier.

2. Device as claimed in claim 1, wherein the layout means (31,32) are arranged for defining the color by specifying a number of entries to be used from a color table, in particular the table being a subpicture color palette stored according to the predefined recording format.

3. Device as claimed in claim 2, wherein the predefined recording format is a DVD format and wherein the layout means (31,32) are arranged for defining the color by specifying 4 entries out of 16 colors defined for the subpicture in a program chain general information (PGC-GI)

4. Device as claimed in claim 1, wherein the layout means (31,32) are arranged for defining additional colors for specific items in the menu, in particular an additional color for a timer indication.

5. Device as claimed in claim 1, wherein the layout means (31,32) are arranged for defining further parameter of menu items, in particular a bitmap and/or position information of a graphical item.

6. Device as claimed in claim 1, wherein the layout means (31,32) are arranged for defining a background image for providing a background for the menu.

7. Device as claimed in claim 1, wherein the menu means (33) are arranged for providing at least one device menu for display on a screen for providing user control of functions of the device, the device menu being generated according to a layout retrieved from the record carrier.

8. Device as claimed any of the claim 1, wherein the layout means (31,32) are arranged for receiving user commands for controlling said defining of the layout.

9. Method of recording information on a record carrier, which method comprises
receiving real-time information, in particular video,
recording marks representing a program according to a predefined recording format, the program including the real-time information and at least one menu for display on a screen for providing user control for accessing the program,
generating the menu according to a layout,
generating the layout, the layout including color parameters for defining the color of items in the menu, and
storing the layout on the record carrier and retrieving the layout from the record carrier.

10. Computer program product for recording information, which program is operative to cause a processor to perform the method as claimed in claim 9.

11. Record carrier for carrying information representing a program according to a predefined recording format, the program including real-time information, in particular video, and at least one menu for display on a screen for providing user control for accessing the program, the record carrier comprising a track (9) containing prerecorded information representing a layout to be used for generating the menu, the layout including color parameters for defining the color of items in the menu.
